(19) United States
(12) Patent Application Publication
(10) Pub. No.: US 2024/0340782 A1
(43) Pub. Date: Oct. 10, 2024

(54) ACCESS NETWORK SELECTION USING SUPPORTED NETWORK SLICE INFORMATION

(71) Applicant: Lenovo (Singapore) Pte. Ltd., New Tech Park (SG)

(72) Inventors: Roozbeh Atarius, La Jolla, CA (US); Apostolis Salkintzis, Athens (GR); Andreas Kunz, Ladenburg (DE); Dimitrios Karampatsis, Ruislip (GB)

(21) Appl. No.: 18/574,272

(22) PCT Filed: Aug. 6, 2021
(86) PCT No.: PCT/EP2021/072055

§ 371 Date: Dec. 26, 2023

(30) Foreign Application Priority Data
Jun. 23, 2021 (GR) 20210100416

(51) Int. Cl. H04W 48/18; H04W 48/16; H04W 84/04; H04W 84/14

(52) U.S. Cl. CPC H04W 48/18; H04W 48/16; H04W 84/042; H04W 84/14

(57) ABSTRACT

Apparatuses, methods, and systems are disclosed for selecting a non-3GPP access network using announced supported S-NSSAIs. One apparatus includes a transceiver and a processor that decides to connect with a first network slice in a first Public Land Mobile Network via a non-3GPP access network. The transceiver sends a first request to each N3AN in a first list of N3ANs, the first request requesting cellular network information, and receives a first response from at least one N3AN in the first list of N3ANs. The processor constructs a second list of N3ANs based on the first response and selects a first N3AN from the second list of N3AN. The transceiver sends a registration request to the first PLMN via the first N3AN, where the registration request indicates that registration with the first network slice is required.

### FIELD

The subject matter disclosed herein relates generally to wireless communications and more particularly relates to selecting an access network based on a list of PLMNs and supported network slices for the PLMNs.

### BACKGROUND

In various wireless systems, a non-3GPP access network may advertise a list of PLMNs to which the non-3GPP access network supports 5G connectivity. This enables a 5G UE to determine which non-3GPP access network can be selected, when the 5G UE wants to register with a specific PLMN over a non-3GPP access network.

Currently when the UE connects to a non-3GPP network, the assumptions is that a non-3GPP access network supports all the S-NSSAIs, however this assumption may not be correct. Therefore, it should be considered how a UE select a non-3GPP access network that can support a specific S-NSSAI.

### BRIEF SUMMARY

Disclosed are procedures for selecting a non-3GPP access network using announced supported S-NSSAIs. Said procedures may be implemented by apparatus, systems, methods, and/or computer program products.

One method of a User Equipment (“UE”) includes deciding to connect with a first network slice in a first Public Land Mobile Network (“PLMN”) via a non-3GPP access network and sending a first request to each non-3GPP access network in a first list of non-3GPP access networks. Here, the first request requesting cellular network information. The first method includes receiving a first response from at least one non-3GPP access network in the first list of non-3GPP access networks, each first response containing a first list of PLMNs and a plurality of supported network slices for each PLMN in the first list of PLMNs.

The method includes constructing a second list of non-3GPP access networks, where each non-3GPP access network in the second list supports connectivity with the first network slice in the first PLMN. The method includes selecting a first non-3GPP access network from the second list of non-3GPP access networks and sending a registration request to the first PLMN via the first non-3GPP access network, where the registration request indicates that registration with the first network slice is required.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for selecting a non-3GPP access network using announced supported S-NSSAIs;

FIG. 2 is a diagram illustrating one embodiment of a network deployment supporting SSID selection for a particular network slice;

FIG. 3 is a flowchart diagram illustrating one embodiment of a procedure for access network selection;

FIG. 4 is a diagram illustrating one embodiment of a GUD and details thereof;

FIG. 5A is a diagram illustrating one embodiment of a PLMN information IE and details thereof;

FIG. 5B is a diagram illustrating another embodiment of a PLMN information IE and details thereof;

FIG. 6 is a diagram illustrating one embodiment of a GUD and details thereof;

FIG. 7A is a diagram illustrating one embodiment of a S-NSSAI list and details thereof;

FIG. 7B is a diagram illustrating another embodiment of a S-NSSAI list and details thereof;

FIG. 8 is a signal flow diagram illustrating one embodiment of a procedure for PDU session establishment by using an S-NSSAI while the UE is connected to the non-3GPP network via a selected SSID associated to the S-NSSAI;

FIG. 9 is a signal flow diagram illustrating another embodiment of a procedure for PDU session establishment by using an S-NSSAI while the UE is connected to the non-3GPP network via a selected SSID associated to the S-NSSAI;

FIG. 10 is a block diagram illustrating one embodiment of a user equipment apparatus that may be used for selecting a non-3GPP access network using announced supported S-NSSAIs;

FIG. 11 is a block diagram illustrating one embodiment of a network apparatus that may be used for selecting a non-3GPP access network using announced supported S-NSSAIs; and

FIG. 12 is a flowchart diagram illustrating one embodiment of a method for selecting a non-3GPP access network using announced supported S-NSSAIs.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for selecting a non-3GPP access network using announced supported S-NSSAIs. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Currently, a non-3GPP access network may advertise a list of PLMNs to which the non-3GPP access network supports 5G connectivity. This enables a 5G UE to determine which non-3GPP access network can be selected, when the 5G UE wants to register with a specific PLMN over a non-3GPP access network.

When a non-3GPP access network advertises that it supports 5G connectivity with a PLMN, it is assumed that the non-3GPP access network supports connectivity to any network slice in this PLMN. However, this assumption may not be valid because a non-3GPP access network may be deployed to support connectivity only to one network slice in the PLMN. Hence, although the non-3GPP access network advertises that it supports 5G connectivity with a PLMN, it is not clear whether the non-3GPP access network supports connectivity to any network slice in the PLMN, or only to a particular set of network slices in the PLMN.

A 5G UE that attempts to select a non-3GPP access network for registering with a particular network slice in a PLMN, needs to know, not only whether a non-3GPP access network supports 5G connectivity with this PLMN, but also whether the non-3GPP access network supports 5G connectivity to the particular network slice in this PLMN. Current standards lack any mechanism to enable the 5G UE know the particular network slices in a PLMN that a non-3GPP access network supports 5G connectivity to.

The Third Generation Partnership Project (“3GPP”) standards organization has defined in 3GPP Technical Standard (“TS”) 24.302, the structure and contents of the Generic Container used as the payload in the 3GPP Cellular Network ANQP-element specified in the Institute of Electrical and Electronics Engineers (“IEEE”) Standard 802.11.

The generic container user data (“GUD”) indicates the protocol version of the generic container (which is currently “00000001”) and the user data header length (“UDHL”) indicates the length of the generic container after UDHL octet. Both GUD and UDHL are encoded in binary format.

The Information Element Identity (“IEI”) are according to 3GPP TS 24.302, currently defined as:
00000000 PLMN List
00000001 PLMN List with S2a connectivity
00000010 PLMN List with trusted 5G connectivity
00000011 PLMN List with trusted 5G connectivity-without-NAS
00000100 Reserved

To
11111111 Reserved.

The information element identities above, may be used by the non-3GPP access network to indicate a list of PLMNs which may provide certain properties such as S2a connectivity or trusted 5G connectivity, can be selected from the wireless location area network (“WLAN”).

In order for the UE to establish a PDU session, it may use a specific S-NSSAI. The UE may be in a tracking area where the S-NSSAI is supported. The UE needs to identify service set identifier (“SSID”) which can be used in the same tracking area in order to attach to the non-3GPP network and establish a PDU session by using the S-NSSAI.

In this embodiment, it is proposed to employ the generic container to indicate one or more single network slice selection assistance information (“S-NSSAIs”), which may be selected from the WLAN. The S-NSSAI format and values may be as defined in subclause 9.11.2.8 of 3GPP TS 24.501 and contain: always one octet as the slice service type (“SST”); [optionally] three octets as the slice differentiator (“SD”); [optionally] one octet as the mapped HPLMN SST; and [optionally] three octets as the mapped HPLMN SD.

Disclosed herein are mechanisms to enable the UE to identify the network slices in a PLMN that a non-3GPP access network supports 5G connectivity to, by querying the non-3GPP access network itself.

In various embodiments, the disclosed mechanism includes the following steps:

First, the UE determines that it needs to register with a particular network slice in PLMN-1 via a trusted non-3GPP access network. This particular network slice is identified by S-NSSAI-x.

Second, the UE may determine that either (a) because it applies a URSP rule, which requires the establishment of a PDU Session to S-NSSAI-x of PLMN-1 via non-3GPP access, or (b) because a UE application requested data connectivity to S-NSSAI-x of PLMN-1.

Third, the UE attempts to discover which of the available non-3GPP access networks support 5G connectivity to S-NSSAI-x of PLMN-1. For this purpose, the UE uses the ANQP protocol (i.e., defined in IEEE 802.11) as follows:

The UE sends an ANQP query request to every available non-3GPP access network.

The ANQP query request contains the Query List ANQP-element, which indicates that “3GPP Cellular Network” information is requested.

Every non-3GPP access network supporting ANQP replies by sending an ANQP query response that contains the “3GPP Cellular Network” ANQP-element. The payload field of the “3GPP Cellular Network” ANQP-element is defined in Annex H of 3GPP TS 24.302. Presently, the payload field of the “3GPP Cellular Network” ANQP-element contains one or more of the following lists:
i. A list of PLMNs with which AAA interworking is supported
ii. A list of PLMNs with which S2a connectivity is supported
iii. A list of PLMNs with which trusted 5G connectivity is supported
iv. A list of PLMNs with which trusted 5G connectivity without NAS is supported

To solve the above mentioned problems with knowing whether a SSID supports a particular S-NSSAI, the PLMN information items in list (iii) may be enhanced to also indicate the S-NSSAIs in a PLMN with which trusted 5G connectivity is supported. For example, the list (iii) provided by a non-3GPP access network could contain:
i. PLMN-1: S-NSSAI-x, S-NSSAI-y
ii. PLMN-2: S-NSSAI-a
iii. PLMN-3: all S-NSSAIs
iv. PLMN-4: S-NSSAI-b

Similarly, the PLMN information items in list (iv) may also be enhanced to indicate the S-NSSAIs in a PLMN with which trusted 5G connectivity is supported. Such enhancements enable a non-3GPP access network to also advertise the network slices in a PLMN with which 5G connectivity without NAS is supported.

Based on all ANQP query responses received, the UE discovers which of the available non-3GPP access networks support 5G connectivity to S-NSSAI-x of PLMN-1. For example, the UE may discover that the non-3GPP access networks identified by SSID-x and SSID-y support 5G connectivity to S-NSSAI-x of PLMN-1.

Fourth, the UE selects one of the discovered non-3GPP access networks that support 5G connectivity to S-NSSAI-x of PLMN-1 (if there are more than one). For this selection, the UE may apply its WLANSP rules (if present) or may select one of these non-3GPP access networks based on its own implementation criteria.

Finally, the UE initiates the 5G registration via trusted non-3GPP access procedure, e.g., as specified in 3GPP TS 23.502, clause 4.12a.2.2. Additionally, the UE registers to S-NSSAI-x of PLMN-1 via the selected non-3GPP access network.

While the above procedure shares steps with the Trusted Non-3GPP Access Network selection procedure in 3GPP TS 23.501, clause 6.3.12. The novel part of the above method is step 3e, which defines amendments to list iii that enable a non-3GPP access network to also advertise the network slices in a PLMN with which 5G connectivity is supported.

In some embodiments, the S-NSSAIs in the ANQP query response may sent in clear. In general, ANQP signaling is not protected because it takes place before the UE connects to the non-3GPP access network and, hence, before security is established. Further, because any UE can send an ANQP query request to retrieve the S-NSSAIs, it may be unnecessary to protect the S-NSSAIs.

In other embodiments, a mobile network operator (“MNO”), i.e., operator of the PLMN, may desire to keep the S-NSSAIs private. In certain embodiments, the UE and the non-3GPP access network may cipher the S-NSSAIs in the ANQP query response, for example by establishing a security association.

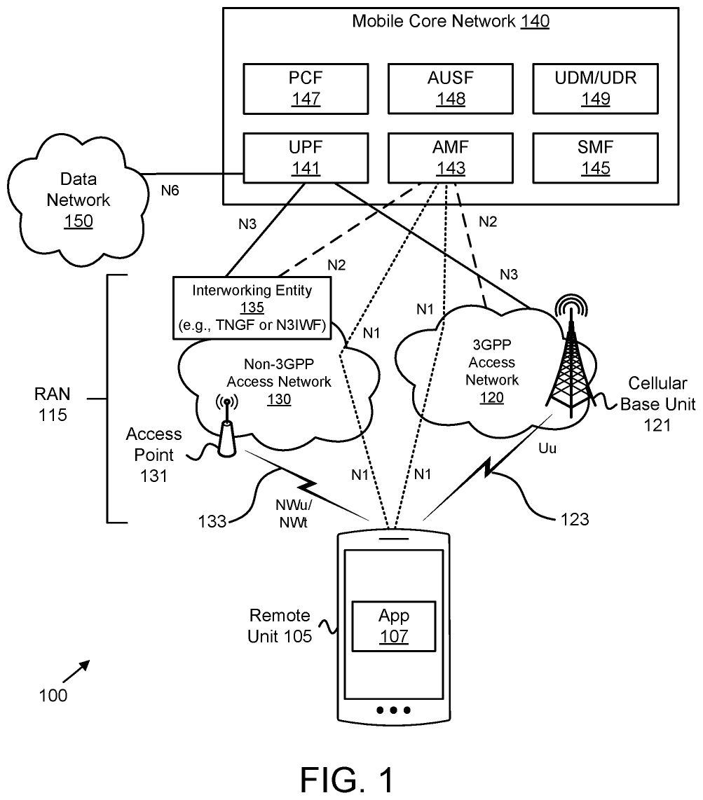

In one embodiment, the wireless communication system 100 includes at least one remote unit 105, a Radio Access Network (“RAN”) 115, and a mobile core network 140. The RAN 115 and the mobile core network 140 form a mobile communication network. The RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 115 is compliant with the Fifth-Generation (“5G”) system specified in the Third Generation Partnership Project (“3GPP”) specifications. For example, the RAN 115 may be a New Generation Radio Access Network (“NG-RAN”), implementing New Radio (“NR”) Radio Access Technology (“RAT”) and/or Long-Term Evolution (“LTE”) RAT. In another example, the RAN 115 may include non-3GPP RAT (e.g., Wi-Fi® or Institute of Electrical and Electronics Engineers (“IEEE”) 802.11-family compliant WLAN). In another implementation, the RAN 115 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network.

In certain embodiments, a non-3GPP access network 130 may be controlled by an operator of the mobile core network 140 and may contain an interworking function that provides direct access to the mobile core network 140. Such a non-3GPP access network deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP access network deployment that is not controlled by an operator (or trusted partner) of the mobile core network 140, does not have direct access to the mobile core network 140, or does not support the certain security features is referred to as a “untrusted” non-3GPP access network. An interworking entity 135 deployed in a trusted non-3GPP access network 130 may be referred to herein as a Trusted Network Gateway Function (“TNGF”). An interworking entity 135 deployed to support interworking with an untrusted non-3GPP access network 130 may be referred to herein as a non-3GPP interworking function (“N3IWF”). Note that the N3IWF is not part of the untrusted non-3GPP access network.

In one embodiment, the mobile core network 140 is a 5G core network (i.e., “5GC”) or an Evolved Packet Core (“EPC”) networks, which may be coupled to the packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the 5G-RAN 115, a Session Management Function (“SMF”) 145, a Policy Control Function (“PCF”) 147, an Authentication Server Function (“AUSF”) 148, a Unified Data Management function (“UDM”) and a User Data Repository (“UDR”).

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The AUSF 148 acts as an authentication server and allows the AMF 143 to authenticate the remote unit 105. The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides NF service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), or other NFs defined for the 5GC. In certain embodiments, the mobile core network 140 may include an authentication, authorization, and accounting (“AAA”) server.

In various embodiments, the each of the mobile core network 140 supports different types of mobile data connections and different types of network slices, wherein each mobile data connection utilizes a specific network slice. Here, a “network slice” refers to a portion of a core network optimized for a certain traffic type or communication service. A network slice instance may be identified by a single-network slice selection assistance information (“S-NSSAI”) while a set of network slices for which the remote unit 105 is authorized to use may be identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140.

While FIG. 1 depicts components of a 5G RAN and a 5G core network, the described embodiments for establishing multiple concurrent registrations with a mobile network apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The RAN 115 refers to any type of 5G access network that can provide access to the mobile core network 140, including the 3GPP access network 120 and the non-3GPP access network 130.

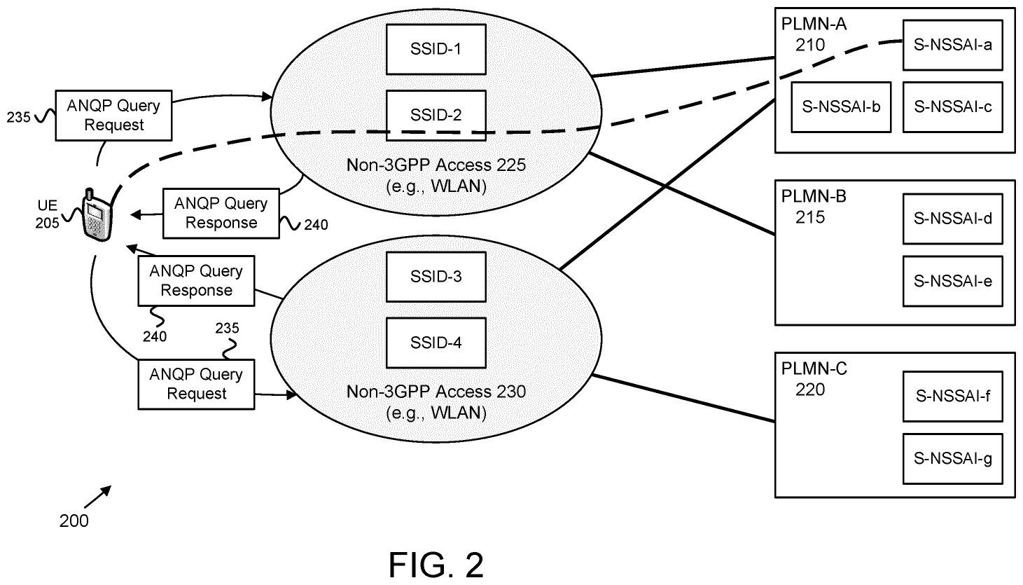

FIG. 2 depicts an example network deployment 200, according to embodiments of the disclosure. The network deployment may be one implementation of the wireless communication system 100, described above. In the depicted embodiments, the network deployment 200 includes a UE 205, which may be an implementation of the remote unit 105. The UE 205 is a subscriber of the PLMN-A 210, which may be an implementation of the mobile core network 140. The UE 205 may connect to the PLMN-A 210 via the non-3GPP access 225, which may be an implementation of the non-3GPP access network 130, described above. In the depicted embodiments, the network deployment 200 also includes the non-3GPP access 230. In certain embodiments, the UE 205 may also connect to the PLMN-A 210 via the non-3GPP accesses 230. Moreover, the UE 205 may connect to a PLMN-B 215 via the non-3GPP access 225 and/or connect to the PLMN-C 220 via the non-3GPP access 230.

Because all non-3GPP accesses that support connections to a particular PLMN may not be able to support all network slices (identified by S-NSSAIs) of the PLMN, the present disclosure describes how the UE 205 is to select a non-3GPP access network that can support a specific S-NSSAI. The described solutions enhance the ANQP query response 240 to include the S-NSSAI list.

To discover which of the available non-3GPP access networks support connectivity to desired network slice of a particular PLMN, the UE 205 uses the ANQP protocol to obtain information on supported PLMNs and S-NSSAI with which trusted 5G connectivity is supported. So, if the UE 205 is to access a non-3GPP network, then the UE 205 may use selection criteria to select a one of the one of the discovered non-3GPP access networks that support connectivity to desired network slice of a particular PLMN (if there are more than one).

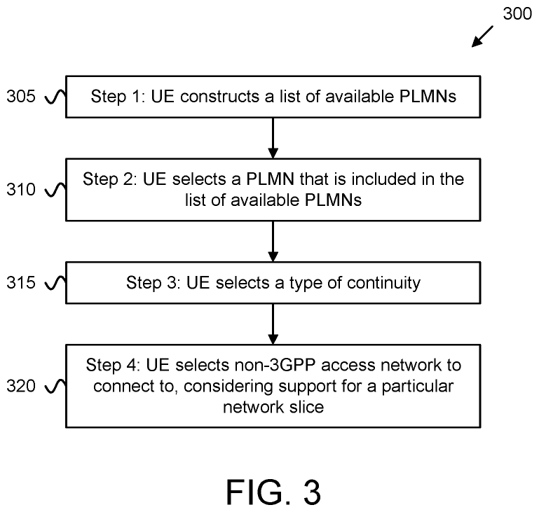

FIG. 3 depicts a procedure 300 for Access Network Selection, according to embodiments of the disclosure. The Access Network Selection procedure 300 may be performed the UE 205. The following steps specify the UE behavior when the UE 205 wants to select and connect to a PLMN over trusted non-3GPP access. Note that the UE 205 executes these steps before connecting to a trusted non-3GPP access network. This is different from the untrusted non-3GPP access, where the UE 205 first connects to a non-3GPP access network, it obtains IP configuration and then proceeds to PLMN selection and N3IWF selection (or enhanced Packet Data Gateway (“ePDG”) selection). In the case of trusted non-3GPP access, the UE 205 uses 3GPP-based authentication for connecting to a non-3GPP access, so it must first select a PLMN and then attempt to connect to a non-3GPP access.

At Step 1, the UE 205 constructs a list of available PLMNs, with which trusted connectivity is supported. This list contains the PLMNs included in the PLMN List-2 (i.e., a list of PLMNs with which S2a connectivity is supported) and the PLMN List-3 (i.e., a list of PLMNs with which trusted 5G connectivity is supported), advertised by all discovered non-3GPP access networks. As described above, the UE 205 may acquire the PLMN lists by sending an ANQP query request to a non-3GPP access network (i.e., WLAN access network) and receiving an ANQP query response, where the PLMN list(s) are contained in the ANQP query response. For each PLMN the supported type(s) of trusted connectivity is also included. As described in further detail below, the ANQP query response may include at least one S-NSSAI list corresponding to the PLMN list(s).

At Step 2, the UE 205 selects a PLMN that is included in the list of available PLMNs, as follows:

If the UE 205 is already connected to a PLMN via 3GPP access and this PLMN is included in the list of available PLMNs, then the UE 205 selects this PLMN. However, if this PLMN is not included in the list of available PLMNs, but it is included in the “Non-3GPP access node selection information” in the UE 205, the UE selects this PLMN and executes a combined ePDG/N3IWF selection procedure. In certain embodiments, the combined ePDG/N3IWF selection procedure is performed as specified in clause 6.3.6.3 of 3GPP TS 23.501.

Otherwise (i.e., if the UE 205 is not connected to a PLMN via 3GPP access, or if the UE 205 is connected to a PLMN via 3GPP access but this PLMN is neither in the list of available PLMNs nor in the “Non-3GPP access node selection information”), then the UE 205 determines the country it is located in.

If the UE 205 determines to be located in its home country, then the UE 205 may select the Home PLMN (“HPLMN”), if included in the list of available PLMNs. Otherwise, the UE selects an E-HPLMN (Equivalent HPLMN) if an E-HPLMN is included in the list of available PLMNs. If the list of available PLMNs does not include the HPLMN and does not include an E-HPLMN, the UE stops the procedure and may attempt to connect via untrusted non-3GPP access (i.e., it may execute the N3IWF selection procedure specified in clause 6.3.6).

Otherwise, if the UE determines to be located in a visited country, then the UE 205 determines if it is mandatory to select a PLMN in the visited country, as follows: If the UE has IP connectivity (e.g., the UE is connected via 3GPP access), the UE sends a Domain Name Service (“DNS”) query and receives a DNS response that indicates if a PLMN must be selected in the visited country. The DNS response also includes a lifetime that denotes how long the DNS response can be cached for. The FQDN in the DNS query shall be different from the Visited Country FQDN (see 3GPP TS 23.003) that is used for ePDG/N3IWF selection. The DNS response shall not include a list of PLMNs that support trusted connectivity in the visited country, but shall only include an indication of whether a PLMN must be selected in the visited country or not. Otherwise, if the UE 205 has no IP connectivity (e.g., the UE is not connected via 3GPP access), then the UE may use a cached DNS response that was received in the past, or may use local configuration that indicates which visited countries mandate a PLMN selection in the visited country.

If the UE 205 determines that it is not mandatory to select a PLMN in the visited country, and the HPLMN or an E-HPLMN is included in the list of available PLMNs, then the UE selects the HPLMN or an E-HPLMN, whichever is included in the list of available PLMNs. Otherwise, the UE selects a PLMN in the visited country by considering, in priority order, the PLMNs, first, in the User Controlled PLMN Selector list and, next, in the Operator Controlled PLMN Selector list (see 3GPP TS 23.122). The UE selects the highest priority PLMN in a PLMN Selector list that is also included in the list of available PLMNs. If the list of available PLMNs does not include a PLMN that is also included in a PLMN Selector list, then the UE 205 stops the procedure and may attempt to connect via untrusted non-3GPP access.

At Step 3, the UE 205 selects the type of trusted connectivity (i.e., “S2a connectivity” or “5G connectivity”) for connecting to the selected PLMN, as follows: If the list of available PLMNs indicates that both “S2a connectivity” and “5G connectivity” is supported for the selected PLMN, then the UE shall select “5G connectivity” because it is the preferred type of trusted access.

Otherwise, if the list of available PLMNs indicates that only one type of trusted connectivity (either “S2a connectivity” or “5G connectivity”) is supported for the selected PLMN, the UE selects this type of trusted connectivity.

At Step 4, the UE 205 selects a non-3GPP access network to connect to, as follows: If the UE selects (in step 3) to use “S2a connectivity” or the UE selects to use “5G connectivity” but does not want to connect to a particular network slice in the selected PLMN, then the UE 205 puts the available non-3GPP access networks in priority order. For WLAN access, the UE 205 constructs a prioritized list of WLAN access networks by using the WLANSP rules (if provided) and the procedure specified in clause 6.6.1.3 of TS 23.503. If the UE is not provided with WLANSP rules, the UE constructs the prioritized list of WLAN access networks by using an implementation specific procedure.

For other types of non-3GPP access, the UE may use access specific information to construct this prioritized list. From the prioritized list of non-3GPP access networks, the UE selects the highest priority non-3GPP access network that supports the selected type of trusted connectivity to the selected PLMN.

Otherwise, i.e., if the UE 205 selects to use “5G connectivity” and the UE 205 wants to connect to a particular network slice in the selected PLMN, then if the UE wants to select a WLAN access network, then the UE discovers which of the available non-3GPP access networks support 5G connectivity to the particular network slice in the selected PLMN. If the UE is provisioned with WLANSP rules from the selected PLMN, then the UE applies the group of selection criteria in an applicable WLANSP rule to select an available WLAN that supports connectivity to the particular network slice in the selected PLMN.

For example, if the UE wants to connect to a network slice of the selected PLMN, which is identified by S-NSSAI-x of PLMN-1, and the UE discovers from the ANQP query responses that the non-3GPP access networks identified by SSID-a and SSID-b support 5G connectivity to S-NSSAI-x of PLMN-1, then the UE selects a WLAN access network identified either with SSID-a or with SSID-b by applying its WLANSP rules.

An example WLANSP rule is as follows:
WLANSP rule:
   Group 1 of WLAN selection criteria: Preferred SSID list=SSID-a, SSID-b

Otherwise, the UE selects a non-3GPP access network as specified above for the case where the UE selects to use “S2a connectivity” or the UE selects to use “5G connectivity” but does not want to connect to a particular network slice.

Finally, over the selected non-3GPP access network, the UE starts the 5GC registration procedure. In some embodiments, the 5GC registration procedure is performed as specified in TS 23.502, clause 4.12a.2.2.

By applying the procedure 300 to the example network deployment depicted in FIG. 2, the UE 205 may perform the following example operation for WLAN access:
1) After discovering available WLAN access network using the ANQP protocol, the UE 205 constructs a list of available PLMNs, with which trusted connectivity is supported. As an example, the UE 205 may construct the following list:
   a. PLMN-A: “S2a connectivity”, “5G connectivity”
   b. PLMN-B: “5G connectivity”
   c. PLMN-C: “S2a connectivity”, “5G connectivity”
2) The UE 205 selects a PLMN that is included in the list of available PLMNs. For example, the UE 205 may select PLMN-A 210 which supports “S2a connectivity” and “5G connectivity”.
3) The UE 205 selects the type of trusted connectivity (“S2a connectivity” or “5G connectivity”) for connecting to the selected PLMN. In this example, the UE 205 selects to use “5G connectivity” to connect to PLMN-A.
4) Having selected to use “5G connectivity” and wanting to connect to a particular network slice in the selected PLMN-A, which is identified by S-NSSAI-a, the UE 205 selects one of the discovered non-3GPP access networks that support 5G connectivity to S-NSSAI-x of PLMN-1 (if there are more than one), e.g., by applying selection criteria of its WLANSP rules.

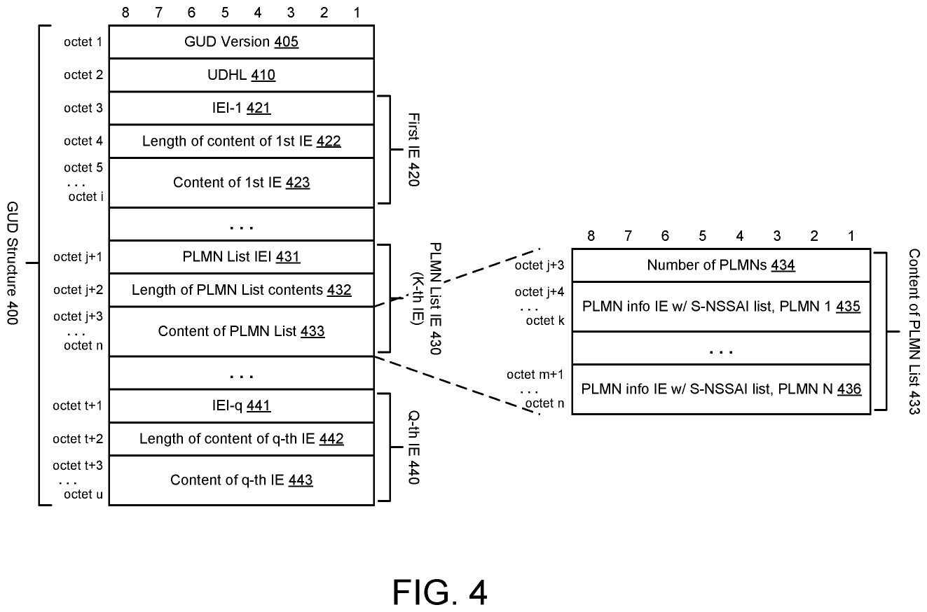

FIG. 4 depicts one example of a Generic container User Data (“GUD”) 400, according to embodiments of the disclosure. In various embodiments, the GUD 400 is received by the UE 205 from a non-3GPP access network 130 in an ANQP query response. The GUD 400 includes a protocol version field 405 (octet 1) and a UDHL field 410 (octet 2) which indicates the length of the GUC 400 after the UDHL field 410. A series of information elements (“IEs”) follow the UDHL field 410.

As depicted, a first IE 420 includes an IE identifier (“IEI”) field 421 (octet 3) and a length of contents field 422 (octet 4), e.g., which indicates the length of the first IE 420 after the length field 422. The first IE 420 includes contents 423 (from octet 5 to octet i). Where the GUD 400 in contained within an ANQP query response, the first IE 420 may be a PLMN list, such as a list of PLMNs with which AAA interworking is supported or a list of PLMNs with which S2a connectivity is supported.

In the depicted embodiment, the k-th IE (octet j+1 to octet k) is a PLMN list 430. Here, the PLMN list 430 is a list of PLMNs with which trusted 5G connectivity is supported. Alternatively, the PLMN list 430 may be a list of PLMNs with which trusted 5G connectivity without NAS is supported.

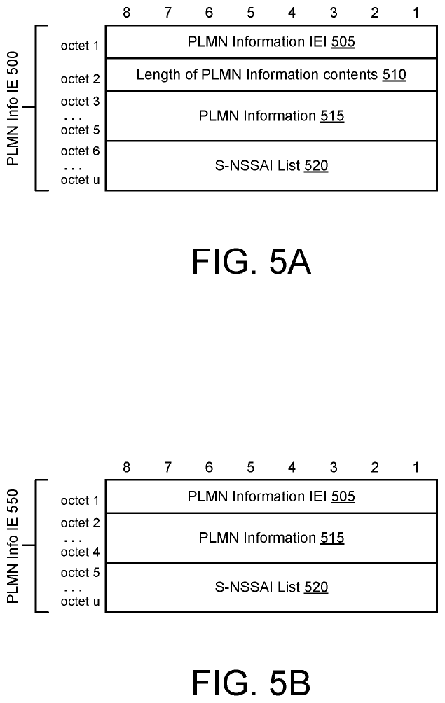

The PLMN list 430 includes an IE identifier (“IEI”) field 431 and a length of contents field 432, e.g., which indicates the length of the PLMN list 430 after the length field 432. The PLMN list 430 include contents 433 which include the number of PLMNs 434 and at least one PLMN information IE. In the depicted embodiment, the PLMN list 430 includes a plurality of PLMN information IEs, from the first PLMN information IE 435 to the N-th PLMN information IE 436. Details of the PLMN information IE are described below with reference to FIGS. 5A-5B. Importantly, the PLMN information IEs of the PLMN list 430 each include a list of S-NSSAI with which trusted connectivity is supported.

According to embodiments of a first solution, the PLMN list information element defined in section H.2.4.2 of 3GPP TS 24.302 is modified to include a new PLMN Information IE that includes a list of supported S-NSSAI.

The GUD 600 may optionally include a q-th IE 440 (octet t+1 to octet u) and possible additional IEs. As depicted, the q-th IE 440 has similar structure to the first IE 420 and includes an IEI field 441, a length of contents field 442 and contents 443.

FIG. 5A depicts a PLMN Information IE 500, which is a first implementation of a PLMN information IE according to embodiments of the first solution. The PLMN Information IE 500 includes a PLMN Information IEI field 505 and a length of PLMN information contents field 510, e.g., which indicates the length of the PLMN Information IE 500 after the length field 510. The PLMN IE 500 also includes the PLMN information item 515, i.e., the Mobile Country Code (“MCC”) and Mobile Network Code (“MNC”) of the PLMN, e.g., as defined in section H.2.4.2 of 3GPP TS 24.302. Additionally, the PLMN Information IE 500 includes a S-NSSAI list 520 for the PLMN identified by the PLMN information item 515. Here, the S-NSSAI list 520 includes at least one S-NSSAI with which trusted connectivity is supported.

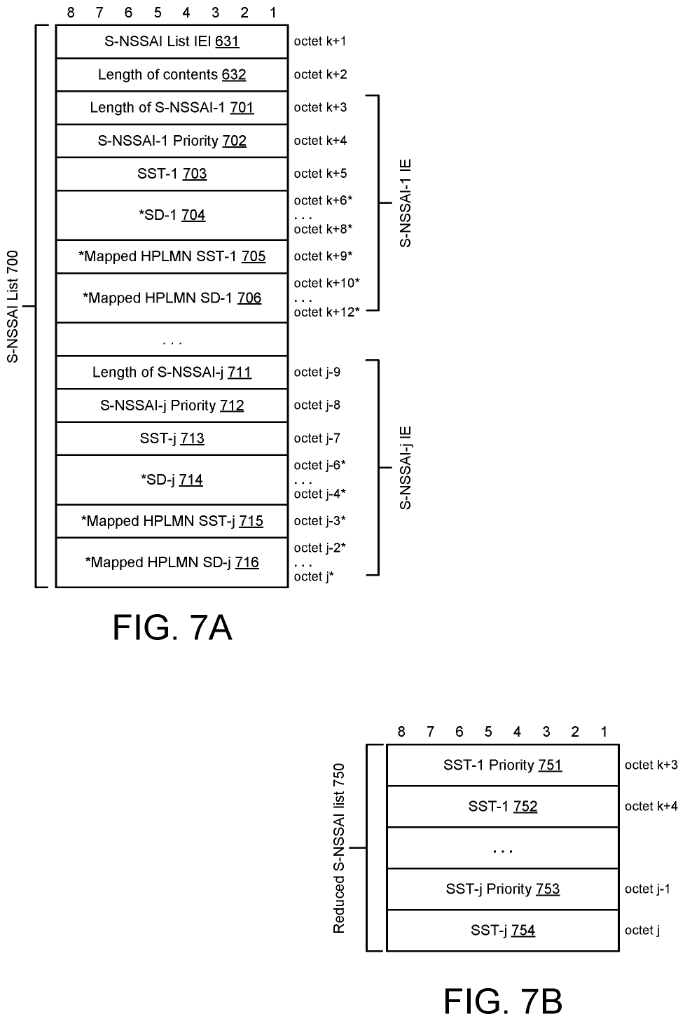

FIG. 5B depicts a PLMN Information IE 550, which is a second implementation of a PLMN information IE according to embodiments of the first solution. The PLMN Information IE 550 includes the PLMN Information IEI field 505 and the PLMN information item 515, i.e., the Mobile Country Code (“MCC”) and Mobile Network Code (“MNC”) of the PLMN, e.g., as defined in section H.2.4.2 of 3GPP TS 24.302. Additionally, the PLMN Information IE 500 includes a S-NSSAI list 520 for the PLMN identified by the PLMN information item 515. Because the PLMN Information IE 550 does not include a length field, the PLMN Information IE 550 requires fewer resources than the PLMN Information IE 500 to transmit to the UE 205, here assuming that each PLMN information IE contains the same S-NSSAI list. Contents of the S-NSSAI list 520 are described below with reference to FIGS. 7A-7B.

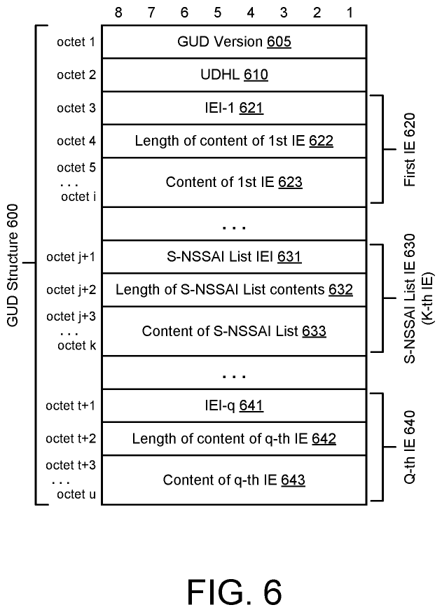

FIG. 6 depicts a Generic container User Data (“GUD”) 600, according to embodiments of the disclosure. In various embodiments, the GUD 600 is received by the UE 205 from a non-3GPP access network 130 in an ANQP query response. The GUD 600 includes a protocol version field 605 (octet 1) and a UDHL field 410 (octet 2) which indicates the length of the GUC 600 after the UDHL field 610. A series of information elements (“IEs”) follow the UDHL field 610.

As depicted, a first IE 620 includes an IE identifier (“IEI”) field 421 (octet 3) and a length of contents field 622 (octet 4) which indicates the length of the first IE 620 after the length field 622. The first IE 620 includes contents 623 (octet 5 to octet i). Where the GUD 400 in contained within an ANQP query response, the first IE 620 may be a PLMN list, such as a list of PLMNs with which AAA interworking is supported, a list of PLMNs with which S2a connectivity is supported, a list of PLMNs with which trusted 5G connectivity is supported, and/or a PLMN with which trusted 5G connectivity without NAS is supported.

In the depicted embodiment, the k-th IE (octet j+1 to octet k) is a S-NSSAI list 630. Here, the S-NSSAI list 630 is a list of S-NSSAIs with which connectivity is supported. In certain embodiments, the S-NSSAI list 630 corresponds to the PLMN(s) of a list of PLMNs with which 5G connectivity is supported.

The S-NSSAI list 630 includes an IE identifier (“IEI”) field 631 and a length of contents field 632, e.g., which indicates the length of the S-NSSAI list 630 after the length field 632. The S-NSSAI list 640 include contents 633 which are described in greater detail below with reference to FIG. 7A-7B.

The GUD 600 may optionally include a q-th IE 640 (octet t+1 to octet u) and possibly additional IEs. As depicted, the q-th IE 640 has similar structure to the first IE 620 and includes an IEI field 641, a length of contents field 642 and contents 643.

According to embodiments of a second solution, the GUD includes a new information element representing list of supported S-NSSAI. In one embodiment, the information element identity (i.e., the binary value in the IEI field 631) may be:
‘00000100’ S-NSSAI list

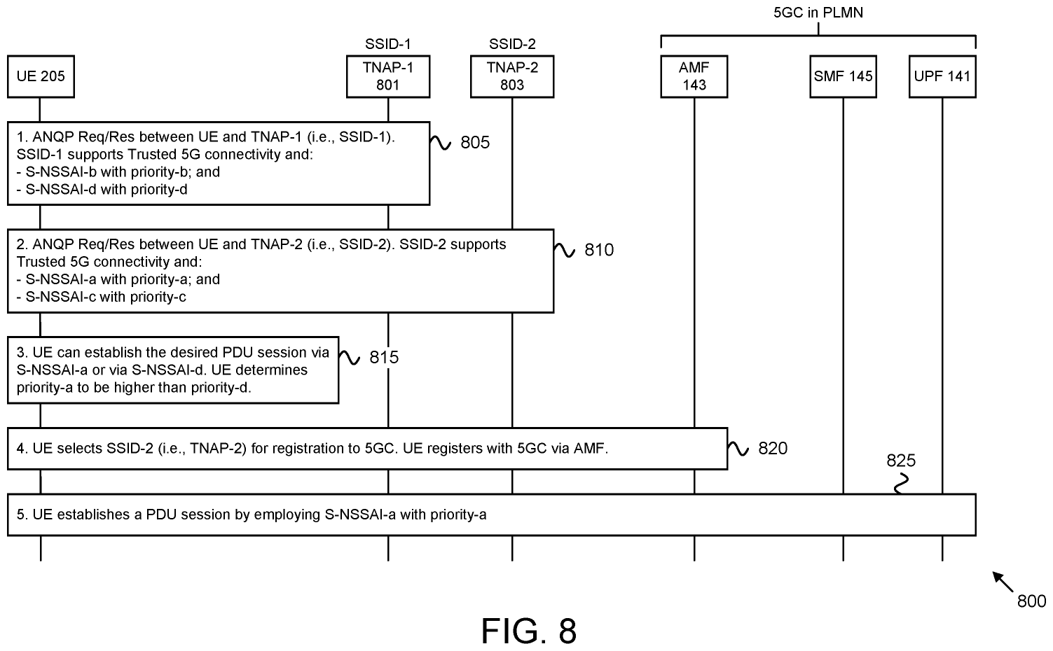

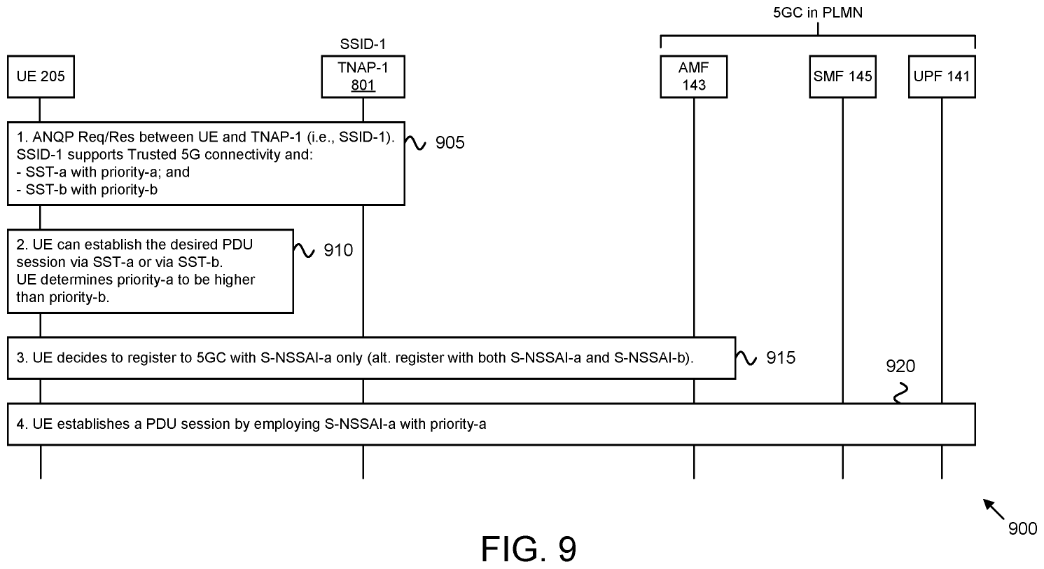

FIG. 7A depicts a S-NSSAI list 700, according to embodiments of the disclosure. A valid S-NSSAI list 700 comprises one or more S-NSSAIs, where the one or more S-NSSAIs are defined according to subclause 9.11.2.8 of 3GPP TS 24.501. As described above, the UE 205 may send an ANQP query request to a detected non-3GPP access network and receive the S-NSSAI list 700 within an ANQP query response. The UE 205 may use the information in the S-NSSAI list 700 to register via a non-3GPP access, as described herein. The UE 205 may then use one or more S-NSSAIs in the S-NSSAI list for the PDU session establishment, as described below with reference to FIGS. 8 and 9.

As depicted, the S-NSSAI list 700 includes a length of list field 631 and a length of contents field 632. Moreover, the S-NSSAI list 700 includes at least one S-NSSAI information element (“IE”). Here, each S-NSSAI IE includes a S-NSSAI priority field and a Slice/Service Type (“SST”) field which refers to the expected Network Slice behavior in terms of features and services.

In the depicted embodiment, the S-NSSAI list 700 includes at least a first S-NSSAI IE and a j-th S-NSSAI IE. Here, the first S-NSSAI IE includes a length of contents field 701, a S-NSSAI priority field 702, and an SST field 703. The first S-NSSAI IE may optionally include a Slice Differentiator (“SD”) field 704 which is optional information that complements the SST(s) to differentiate amongst multiple Network Slices of the same SST. Because the particular SST and SD values in the serving PLMN may differ from those used by the HPLMN of the UE 205, the first S-NSSAI IE may optionally include a mapped HPLMN SST value 705 and possibly a mapped HPLMN SD value 706. These mapped values allow the UE 205 to identify S-NSSAI in the serving PLMN that correspond to specific S-NSSAI in the HPLMN.

Similarly, the j-th S-NSSAI IE includes a length of contents field 711, a S-NSSAI priority field 712, and an SST field 713. The j-th S-NSSAI IE may optionally include a SD field 704 which is optional information that complements the SST(s) to differentiate amongst multiple Network Slices of the same SST. Moreover, the j-th S-NSSAI IE may optionally include a mapped HPLMN SST value 715 and possibly a mapped HPLMN SD value 716.

Where the S-NSSAI list is separate from the PLMN list, an S-NSSAI IE may include an indication of which PLMN from the PLMN list the S-NSSAI IE corresponds to (not depicted in FIG. 7A) In other embodiments, the S-NSSAI-to-PLMN correspondence information is not included in the S-NSSAI IE as this information is already known to the UE or implicit (e.g., due to the S-NSSAI list being found within a PLMN info IE. Note that presence of SD, mapped HPLMN SST and mapped SD are optional. This optionality of the SD, mapped HPLMN SST and mapped HPLMN SD are shown by the addition of the symbol “*” next to the octet numbers in FIG. 7A.

FIG. 7B depicts a reduced S-NSSAI list 750, according to embodiments of the disclosure. A valid S-NSSAI list 750 comprises one or more S-NSSAIs, where the one or more S-NSSAIs are defined according to subclause 9.11.2.8 of 3GPP TS 24.501. As described above, the UE 205 may send an ANQP query request to a detected non-3GPP access network and receive the S-NSSAI list 750 within an ANQP query response. The UE 205 may use the information in the S-NSSAI list 750 to register via a non-3GPP access, as described herein. The UE 205 may then use one or more S-NSSAIs in the S-NSSAI list for the PDU session establishment, as described below with reference to FIGS. 8 and 9.

As depicted, the S-NSSAI list 700 includes a length of list field 631 and a length of contents field 632. Moreover, the S-NSSAI list 700 includes at least one S-NSSAI information element (“IE”). Here, each S-NSSAI IE includes a Slice/Service Type (“SST”) priority field and a Slice/Service Type (“SST”) field which refers to the expected Network Slice behavior in terms of features and services. Specifically, the first S-NSSAI IE (comprising fields 751 and 752) includes the SST priority field 751 and the SST field 752. The j-th S-NSSAI IE (comprising fields 753 and 754) includes the SST priority field 753 and the SST field 754. Because the SD, the mapped HPLMN SST and the mapped HPLMN SD are optional fields, the S-NSSAI list 750 represents a special case of the S-NSSAI list 700, where the S-NSSAI list contains only the one or more SSTs and their related priorities. Because SST priority field (751, 753) and SST field (752, 754) have known lengths, there is no need to have a parameter representing the length of an S-NSSAI IE in the case of the reduces S-NSSAI list 750.

All the fields in FIG. 7A and FIG. 7B may be represented in binary format. The priority field may represent the priority of an SST or S-NSSAI. The UE which may be able to establish a PDU session by two or more SSTs or S-NSSAIs may use the priority field to determine which SST or S-NSSAI may be used.

In some embodiments, S-NSSAI lists 700 and/or 750 may not include priority octet. In that embodiment, the octet for “S-NSSAI Priority” in FIG. 7A and the octet for “SST Priority” in FIG. 7B may be either set to a void value or omitted. In such embodiments, the S-NSSAI list may be treated as a prioritized list, where the priority of each S-NSSAI is indicated by its position in the list (i.e., beginning with the highest priority S-NSSAI). In other embodiments, the S-NSSAI in the list may be treated as all having the same priority.

Where the S-NSSAI list is separate from the PLMN list, an S-NSSAI IE may include an indication of which PLMN from the PLMN list the S-NSSAI IE corresponds to (not depicted in FIG. 7A nor FIG. 7B) In other embodiments, the S-NSSAI-to-PLMN correspondence information is not included in the S-NSSAI IE as this information is already known to the UE or implicit (e.g., due to the S-NSSAI list being found within a PLMN info IE.

FIG. 8 depicts signaling flow of a procedure 800 for PDU session establishment by using an S-NSSAI while the UE is connected to the non-3GPP network via a selected SSID associated to the S-NSSAI, according to embodiments of the disclosure. The procedure 800 involves the UE 205, a first trusted non-3GPP access point (“TNAP”) 801, a second TNAP 803, the AMF 143, the SMF 145, and the UPF 141. Here, the AMF 143, SMF 145, and UPF 141 are network functions in a 5GC, wherein the UE 205 may register with a network slice in the 5GC via a non-3GPP RAN 130 comprising the first TNAP 801 and second TNAP 803.

As discussed above, the UE 205 may use the ANQP protocol to discover which of the available non-3GPP access networks support 5G connectivity to a particular network slice in a desired PLMN. The detailed description of the FIG. 8 is as follows:

At Step 1, in order for a UE to connect to a trusted non-3GPP network the UE, the UE uses the ANQP request/response mechanism to get the information element identities (“IEIs”) from the first TNAP 801 with SSID-1 (see block 805).

According to embodiments of the first solution, the IEIs may comprise PLMN list with trusted 5G connectivity with or without NAS capability, where the PLMN list comprises the S-NSSAI list with S-NSSAI-b with priority-b and S-NSSAI-d with priority-d. Examples of a PLMN list comprising a S-NSSAI list are described above with reference to FIG. 4, FIG. 5A and FIG. 5B.

According to embodiments of the second solution, the IEIs received from the first TNAP 801 may comprise PLMN list with trusted 5G connectivity with or without NAS capability and S-NSSAI-b with priority-b and S-NSSAI-d with priority-d. Examples of a GUD comprising a S-NSSAI list are described above with reference to FIG. 6. Examples of a S-NSSAI list are described above with reference to FIGS. 7A and 7B.

At Step 2, the UE 205 may use the ANQP request/response mechanism (IEEE Std 802.11) to get information element identities from the trusted access two with SSID-2.

According to embodiments of the first solution, the IEIs may comprise PLMN list with trusted 5G connectivity with or without NAS capability, where the PLMN list comprises the S-NSSAI list with S-NSSAI-a with priority-a and S-NSSAI-c with priority-c. Examples of a PLMN list comprising a S-NSSAI list are described above with reference to FIG. 4, FIG. 5A and FIG. 5B.

According to embodiments of the second solution, the IEIs received from the second TNAP 803 may comprise PLMN list with 5G connectivity and S-NSSAI-a with priority-a, S-NSSAI-c with priority-c. Examples of a GUD comprising a S-NSSAI list are described above with reference to FIG. 6. Examples of a S-NSSAI list are described above with reference to FIGS. 7A and 7B.

At Step 3, because the UE 205 is to select a trusted access point with capability for S-NSSAI-a or S-NSSAI-d in order to establish a certain PDU session, then UE 205 chooses the trusted access point by comparing priority-a and priority-d (see block 815).

At Step 4, because priority-a is more than priority-d, the UE 205 chooses the second TNAP 803 (having SSID-2) to register to the trusted non-3GPP access (see block 820). In various embodiments, the UE performs a registration procedure according to 3GPP TS 23.502.

At Step 5, upon completing a successful registration via the TNAP 803 with SSID-2, the UE 205 establishes a PDU session by employing S-NSSAI-a (see block 825).

Note that the S-NSSAIs and their related priorities in the example illustrated in FIG. 8 may be replaced with SSTs and the related priorities, i.e., for the case where the S-NSSAI list comprises only SSTs and the related priorities.

FIG. 9 depicts signaling flow of a procedure 900 for PDU session establishment by using an S-NSSAI while the UE is connected to the non-3GPP network via a selected SSID associated to the S-NSSAI, according to embodiments of the disclosure. The procedure 900 involves the UE 205, the first TNAP 801, the AMF 143, the SMF 145, and the UPF 141. Here, the AMF 143, SMF 145, and UPF 141 are network functions in a 5GC, wherein the UE 205 may register with a network slice in the 5GC via a non-3GPP RAN 130 comprising the first TNAP 801.

As discussed above, the UE 205 may use the ANQP protocol to discover which of the available non-3GPP access networks support 5G connectivity to a particular network slice in a desired PLMN. The detailed description of the FIG. 9 is as follows:

At Step 1, in order for a UE to connect to a trusted non-3GPP network the UE, the UE uses the ANQP request/response mechanism to get the information element identities (“IEIs”) from the first TNAP 801 with SSID-1 (see block 905).

According to embodiments of the first solution, the IEIs may comprise PLMN list with trusted 5G connectivity with or without NAS capability, where the PLMN list comprises the S-NSSAI list with S-NSSAI-b with priority-b and S-NSSAI-d with priority-d. Examples of a PLMN list comprising a S-NSSAI list are described above with reference to FIG. 4, FIG. 5A and FIG. 5B.

According to embodiments of the second solution, the IEIs may comprise PLMN list with trusted 5G connectivity with or without NAS capability and S-NSSAI-b with priority-b and S-NSSAI-d with priority-d. Examples of a GUD comprising a S-NSSAI list are described above with reference to FIG. 6. Examples of a S-NSSAI list are described above with reference to FIGS. 7A and 7B.

At Step 2, because the UE 205 is to select a trusted access point with capability for S-NSSAI-a or S-NSSAI-b in order to establish a certain PDU session, then UE 205 chooses the trusted access point by comparing priority-a and priority-b (see block 910).

At Step 3, as only one TNAP supports connectivity to the selected PLMN, the UE 205 chooses to the TNAP 801 (i.e., having SSID-1) to register to the 5GC (see block 915). Moreover, because priority-a is more than priority-b, the UE 205 determines to register with S-NSSAI-a via the TNAP 801. Alternatively, the UE 205 may decide to register with both S-NSSAI-a and S-NSSAI-b. In various embodiments, the UE 205 performs a registration procedure according to 3GPP TS 23.502.

At Step 4, upon completing a successful registration via the TNAP 801 with SSID-1, the UE establishes a PDU session by employing S-NSSAI-a (see block 920).

Note that the S-NSSAIs and their related priorities in the example illustrated in FIG. 9 may be replaced with SSTs and the related priorities, i.e., for the case where the S-NSSAI list comprises only SSTs and the related priorities.

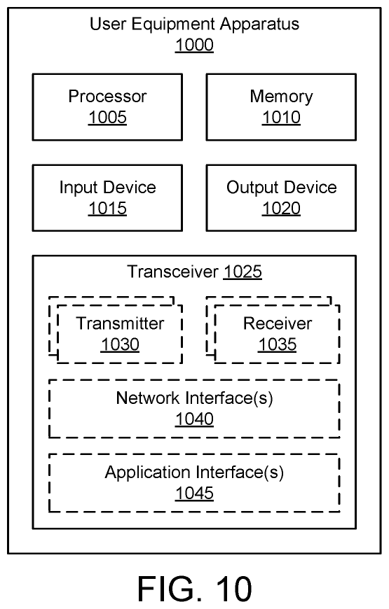

FIG. 10 depicts a user equipment apparatus 1000 that may be used for selecting a non-3GPP access network using announced supported S-NSSAIs, according to embodiments of the disclosure. In various embodiments, the user equipment apparatus 1000 is used to implement one or more of the solutions described above. The user equipment apparatus 1000 may be one embodiment of the remote unit 105 and/or the UE 205, described above. Furthermore, the user equipment apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the user equipment apparatus 1000 may not include any input device 1015 and/or output device 1020. In various embodiments, the user equipment apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. In some embodiments, the transceiver 1025 communicates with one or more cells (or wireless coverage areas) supported by one or more base units 121. In various embodiments, the transceiver 1025 is operable on unlicensed spectrum. Moreover, the transceiver 1025 may include multiple UE panel supporting one or more beams. Additionally, the transceiver 1025 may support at least one network interface 1040 and/or application interface 1045. The application interface(s) 1045 may support one or more APIs. The network interface(s) 1040 may support 3GPP reference points, such as NWt, NWu, Uu, N1, etc. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025. In certain embodiments, the processor 1005 may include an application processor (also known as “main processor”) which manages application-domain and operating system (“OS”) functions and a baseband processor (also known as “baseband radio processor”) which manages radio functions.

In various embodiments, the processor 1005 controls the user equipment apparatus 1000 to implement the above described UE behaviors. For example, the processor 1005 may decide to connect with a first network slice in a first PLMN via a N3AN. The processor 1005 controls the transceiver 1025 to send a first request (e.g., ANQP query request) to each N3AN in a first list of N3ANs (e.g., available N3ANs), where the first request is a query for cellular network information (e.g., contains the “3GPP Cellular Network” ANQP-element). Via the transceiver 1025, the processor 1005 receives a first response (e.g., ANQP query response) from at least one N3AN in the first list of N3ANs. Here, each first response contains a first list of PLMNs (e.g., PLMNs with which 5G connectivity is supported) and a plurality of supported network slices for each PLMN in the first list of PLMNs.

The processor 1005 further constructs a second list of N3ANs, where each N3AN in the second list supports connectivity with the first network slice in the first PLMN, and selects a first N3AN from the second list of N3AN. Via the transceiver 1025, the processor 1005 sends a registration request to the first PLMN via the first N3AN, where the registration request indicates that registration with the first network slice is required. In some embodiments, a registration request indicates that registration with the first network slice is required by including the identity of the first network slice in the Request NSSAI information element, which is part of the registration request message.

In some embodiments, receiving the first response contains receiving a generic container that contains the first list of PLMNs and the plurality of supported network slices, e.g., S-NSSAI list that identifies a set of network slices for each PLMN in the first list of PLMNs. In some embodiments, each PLMN in the first list of PLMNs identifies a PLMN with which 5G connectivity is supported by the N3AN that sent the first list of PLMNs.

In some embodiments, the first list of PLMNs contains a set of PLMN information elements. In such embodiments, each PLMN information element includes a PLMN identity and a S-NSSAI list. In certain embodiments, each S-NSSAI in the S-NSSAI list includes an SST value and a SD value.

In some embodiments, selecting the first N3AN includes applying one or more selection policy rules (e.g., WLANSP rules) to select a highest priority N3AN from the second list of N3ANs. In certain embodiments, each S-NSSAI in the S-NSSAI list includes an SST value and a priority value.

In some embodiments, the processor 1005 further establishes a data connection (i.e., PDU Session) with the first network slice. In certain embodiments, the first N3AN includes a trusted WLAN access network. In such embodiments, the data connection with the first network slice may include a PDU session established via the trusted WLAN.

In some embodiments, deciding to connect with the first network slice occurs in response to receiving an internal request to establish a data connection with a first network slice. Here, the request is generated by one of: a UE application, and a URSP rule in the UE, where the URSP rule indicates that the data connection with the first network slice should be established over a N3AN.

In various embodiments, the processor 1005 detects a trigger to register with a particular network slice in a first PLMN via a N3AN. Via the transceiver 1025, the processor 1005 receives a PLMN list and at least one S-NSSAI list from a network entity (e.g., from a first N3AN). Here, the PLMN list including a first PLMN, where the at least one S-NNSAI list indicates a set of S-NSSAI corresponding to the first PLMN. The processor 1005 selects a N3AN based on the S-NSSAI list, where the selected N3AN supports connectivity to a particular network slice of the first PLMN. The processor 1005 registers with the particular network slice of the first PLMN over the selected N3AN, where the registration allows a S-NSSAI corresponding to the particular network slice.

In some embodiments, receiving the PLMN list and the S-NSSAI list includes receiving a generic container user data (“GUD”) that contains the PLMN list and the S-NSSAI list.

In some embodiments, the PLMN list contains a set of PLMN information elements with which the network entity supports trusted 5G connectivity. Here, each PLMN information element may include a PLMN identity and a S-NSSAI list.

In some embodiments, the S-NSSAI list identifies a set of network slices for each PLMN in the PLMN list, where the network entity supports trusted 5G connectivity with each network slice identified by the S-NSSAI list. In some embodiments, the trigger comprises a request generated by one of: a UE application, and a URSP rule at the UE.

In some embodiments, each S-NSSAI in the S-NSSAI list contains an SST. In certain embodiments, at least one S-NSSAI in the S-NSSAI list also contains a mapped HPLMN SST. In some embodiments, at least one S-NSSAI in the S-NSSAI list contains a both an SST and a SD. In further embodiments, at least one S-NSSAI in the S-NSSAI list contains a mapped HPLMN SST and a mapped home PLMN SD.

In some embodiments, selecting the N3AN based on the S-NSSAI list includes analyzing the S-NSSAI list to identify a set of candidate N3ANs that support 5G connectivity to the particular network slice of the first PLMN. In certain embodiments, selecting the N3AN further comprises applying one or more selection policy rules (e.g., WLANSP rules) to select a highest priority N3AN from the set of candidate N3ANs. In such embodiments, each S-NSSAI in the S-NSSAI list may contain an SST and a priority value. In further embodiments, at least one S-NSSAI in the S-NSSAI list may also contain a mapped HPLMN SST, a SD and/or a mapped HPLMN SD.

In some embodiments, the processor 1005 establishing a data connection with the particular network slice. In certain embodiments, the selected N3AN comprises a trusted WLAN access network. In such embodiments, the data connection with the particular network slice comprises a PDU session established via the trusted WLAN.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to mobile operation. For example, the memory 1010 may store various parameters, configurations, resource assignments, policies, and the like as described above. In certain embodiments, the memory 1010 also stores program code and related data, such as an operating system or other controller algorithms operating on the user equipment apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1020 may include a wearable display separate from, but communicatively coupled to, the rest of the user equipment apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 communicates with one or more network functions of a mobile communication network via one or more access networks. The transceiver 1025 operates under the control of the processor 1005 to transmit messages, data, and other signals and also to receive messages, data, and other signals. For example, the processor 1005 may selectively activate the transceiver 1025 (or portions thereof) at particular times in order to send and receive messages.

The transceiver 1025 includes at least transmitter 1030 and at least one receiver 1035. One or more transmitters 1030 may be used to provide UL communication signals to a base unit 121, such as the UL transmissions described herein. Similarly, one or more receivers 1035 may be used to receive DL communication signals from the base unit 121, as described herein. Although only one transmitter 1030 and one receiver 1035 are illustrated, the user equipment apparatus 1000 may have any suitable number of transmitters 1030 and receivers 1035. Further, the transmitter(s) 1030 and the receiver(s) 1035 may be any suitable type of transmitters and receivers. In one embodiment, the transceiver 1025 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1025, transmitters 1030, and receivers 1035 may be implemented as physically separate components that access a shared hardware resource and/or software resource, such as for example, the network interface 1040.

In various embodiments, one or more transmitters 1030 and/or one or more receivers 1035 may be implemented and/or integrated into a single hardware component, such as a multi-transceiver chip, a system-on-a-chip, an Application Specific Integrated Circuit (“ASIC”), or other type of hardware component. In certain embodiments, one or more transmitters 1030 and/or one or more receivers 1035 may be implemented and/or integrated into a multi-chip module. In some embodiments, other components such as the network interface 1040 or other hardware components/circuits may be integrated with any number of transmitters 1030 and/or receivers 1035 into a single chip. In such embodiment, the transmitters 1030 and receivers 1035 may be logically configured as a transceiver 1025 that uses one more common control signals or as modular transmitters 1030 and receivers 1035 implemented in the same hardware chip or in a multi-chip module.

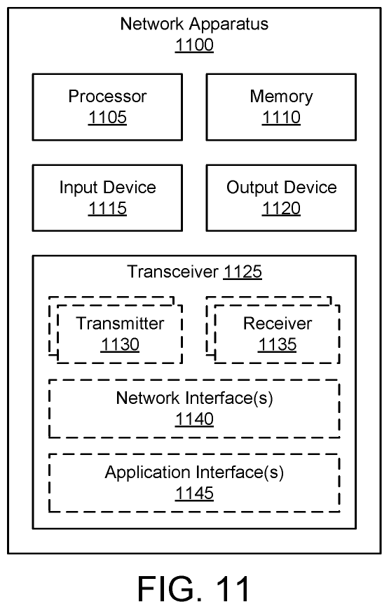

FIG. 11 depicts a network apparatus 1100 that may be used for selecting a non-3GPP access network using announced supported S-NSSAIs, according to embodiments of the disclosure. In one embodiment, network apparatus 1100 may be one implementation of an access management function in a mobile communication network, such as the AMF 143, described above. Furthermore, the network apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the network apparatus 1100 may not include any input device 1115 and/or output device 1120. In various embodiments, the network apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more remote units 105. Additionally, the transceiver 1125 may support at least one network interface 1140 and/or application interface 1145. The application interface(s) 1145 may support one or more APIs. The network interface(s) 1140 may support 3GPP reference points, such as NWu, Uu, N1, N2, N3, N4, etc. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a CPU, a GPU, an auxiliary processing unit, a FPGA, or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125. When implementing a RAN node, the processor 1105 may include an application processor (also known as “main processor”) which manages application-domain and operating system (“OS”) functions and a baseband processor (also known as “baseband radio processor”) which manages radio functions.

In various embodiments, the processor 1105 controls the network apparatus 1100 to implement the above described N3AN behaviors. For example, via the transceiver 1125 the processor 1105 may receive a first request (e.g., ANQP query request) from a UE, the first request requesting cellular network information (e.g., by containing the “3GPP Cellular Network” ANQP-element). Further, the processor 1105 may control the transceiver 1125 to send a first response (e.g., ANQP query response) to the UE, the first response containing a first list of PLMNs with which the apparatus 1100 supports 5G connectivity and a plurality of supported network slices for each PLMN in the first list of PLMNs. In certain embodiments, the plurality of supported network slices may comprise at least one S-NSSAI list, as described above.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to selecting a non-3GPP access network using announced supported S-NSSAIs. For example, the memory 1110 May store parameters, configurations, resource assignments, policies, and the like, as described above. In certain embodiments, the memory 1110 also stores program code and related data, such as an operating system or other controller algorithms operating on the network apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the network apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. One or more transmitters 1130 may be used to communicate with the UE, as described herein. Similarly, one or more receivers 1135 may be used to communicate with network functions in the core network (e.g., 5GC, EPC) and/or RAN, as described herein. Although only one transmitter 1130 and one receiver 1135 are illustrated, the network apparatus 1100 may have any suitable number of transmitters 1130 and receivers 1135. Further, the transmitter(s) 1130 and the receiver(s) 1135 may be any suitable type of transmitters and receivers.

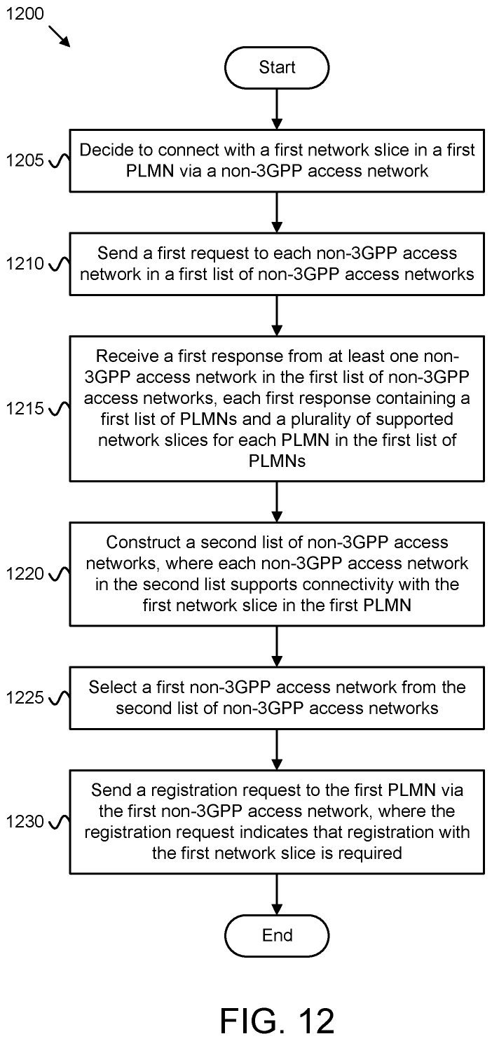

FIG. 12 depicts one embodiment of a method 1200 for selecting a non-3GPP access network using announced supported S-NSSAIs, according to embodiments of the disclosure. In various embodiments, the method 1200 is performed by a user equipment device in a mobile communication network, such as the remote unit 105, the UE 205, and/or the user equipment apparatus 1000, described above. In some embodiments, the method 1200 is performed by a processor, such as a microcontroller, a microprocessor, a CPU, a GPU, an auxiliary processing unit, a FPGA, or the like.

The method 1200 begins and decides 1205 to connect with a first network slice in a first PLMN via a non-3GPP access network. The method 1200 includes sending 1210 a first request to each non-3GPP access network in a first list of non-3GPP access networks. Here, the first request requesting cellular network information. The method 1200 includes receiving 1215 a first response from at least one non-3GPP access network in the first list of non-3GPP access networks, each first response containing a first list of PLMNs and a plurality of supported network slices for each PLMN in the first list of PLMNs.

The method 1200 includes constructing 1220 a second list of non-3GPP access networks, where each non-3GPP access network in the second list supports connectivity with the first network slice in the first PLMN. The method 1200 includes selecting 1225 a first non-3GPP access network from the second list of non-3GPP access networks. The method 1200 includes sending 1230 a registration request to the first PLMN via the first non-3GPP access network, where the registration request indicates that registration with the first network slice is required. The method 1200 ends.

Disclosed herein is a first apparatus for selecting a non-3GPP access network using announced supported S-NSSAIs, according to embodiments of the disclosure. The first apparatus may be implemented by a user equipment device in a mobile communication network, such as the remote unit 105, the UE 205, and/or the user equipment apparatus 1000, described above. The first apparatus includes a transceiver and a processor that decides to connect with a first network slice in a first PLMN via a N3AN. The processor controls the transceiver to send a first request (e.g., ANQP query request) to each N3AN in a first list of N3ANS (e.g., available N3ANs), where the first request is a query for cellular network information (e.g., contains the “3GPP Cellular Network” ANQP-element). Via the transceiver, the processor receives a first response (e.g., ANQP query response) from at least one N3AN in the first list of N3ANs. Here, each first response contains a first list of PLMNs (e.g., PLMNs with which 5G connectivity is supported) and a plurality of supported network slices for each PLMN in the first list of PLMNs.

The processor further constructs a second list of N3ANs, where each N3AN in the second list supports connectivity with the first network slice in the first PLMN, and selects a first N3AN from the second list of N3AN. Via the transceiver, the processor sends a registration request to the first PLMN via the first N3AN, where the registration request indicates that registration with the first network slice is required.

In some embodiments, receiving the first response contains receiving a generic container that contains the first list of PLMNs and the plurality of supported network slices, e.g., S-NSSAI list that identifies a set of network slices for each PLMN in the first list of PLMNs. In some embodiments, each PLMN in the first list of PLMNs identifies a PLMN with which 5G connectivity is supported by the N3AN that sent the first list of PLMNs.

In some embodiments, the first list of PLMNs contains a set of PLMN information elements. In such embodiments, each PLMN information element includes a PLMN identity and a S-NSSAI list. In certain embodiments, each S-NSSAI in the S-NSSAI list includes an SST value and a SD value.

In some embodiments, selecting the first N3AN includes applying one or more selection policy rules (e.g., WLANSP rules) to select a highest priority N3AN from the second list of N3ANs. In certain embodiments, each S-NSSAI in the S-NSSAI list includes an SST value and a priority value.

In some embodiments, the processor further establishes a data connection (i.e., PDU Session) with the first network slice. In certain embodiments, the first N3AN includes a trusted WLAN access network. In such embodiments, the data connection with the first network slice may include a PDU session established via the trusted WLAN.

In some embodiments, deciding to connect with the first network slice occurs in response to receiving an internal request to establish a data connection with a first network slice. Here, the request is generated by one of: a UE application, and a URSP rule in the UE, where the URSP rule indicates that the data connection with the first network slice should be established over a N3AN.

Disclosed herein is a first method for selecting a non-3GPP access network using announced supported S-NSSAIs, according to embodiments of the disclosure. The first method may be performed by a user equipment device in a mobile communication network, such as the remote unit 105, the UE 205, and/or the user equipment apparatus 1000. The first method includes deciding to connect with a first network slice in a first PLMN via a N3AN and sending a first request (e.g., an ANQP query request) to each N3AN in a first list of N3ANs (e.g., the available N3ANS). Here, the first request is a query for cellular network information (e.g., contains the “3GPP Cellular Network” ANQP-element).

The first method includes receiving a first response (e.g., an ANQP query response) from at least one N3AN in the first list of N3ANs. Here, each first response contains a first list of PLMNs (e.g., PLMNs with which 5G connectivity is supported) and a plurality of supported network slices for each PLMN in the first list of PLMNs. The first method includes constructing a second list of N3ANs, where each N3AN in the second list supports connectivity with the first network slice in the first PLMN. The first method includes selecting a first N3AN from the second list of N3ANs and sending a registration request to the first PLMN via the first N3AN, where the registration request indicates that registration with the first network slice is required.

In some embodiments, receiving the first response contains receiving a generic container that contains the first list of PLMNs and the plurality of supported network slices, e.g., S-NSSAI list that identifies a set of network slices for each PLMN in the first list of PLMNs. In some embodiments, each PLMN in the first list of PLMNs identifies a PLMN with which 5G connectivity is supported by the N3AN that sent the first list of PLMNs.

In some embodiments, the first list of PLMNs contains a set of PLMN information elements. In such embodiments, each PLMN information element includes a PLMN identity and a S-NSSAI list. In certain embodiments, each S-NSSAI in the S-NSSAI list includes an SST value and a SD value.

In some embodiments, selecting the first N3AN includes applying one or more selection policy rules (e.g., WLANSP rules) to select a highest priority N3AN from the second list of N3ANs. In certain embodiments, each S-NSSAI in the S-NSSAI list includes an SST value and a priority value.

In some embodiments, the first method further includes establishing a data connection (i.e., PDU Session) with the first network slice. In certain embodiments, the first N3AN includes a trusted WLAN access network. In such embodiments, the data connection with the first network slice may include a PDU session established via the trusted WLAN.

In some embodiments, deciding to connect with the first network slice occurs in response to receiving an internal request to establish a data connection with a first network slice. Here, the request is generated by one of: a UE application, and a URSP rule in the UE, where the URSP rule indicates that the data connection with the first network slice should be established over a N3AN.

Disclosed herein is a second apparatus for selecting a non-3GPP access network using announced supported S-NSSAIs, according to embodiments of the disclosure. The second apparatus may be implemented by a user equipment device in a mobile communication network, such as the remote unit 105, the UE 205, and/or the user equipment apparatus 1000, described above. The second apparatus includes a transceiver and a processor that detects a trigger to register with a particular network slice in a first PLMN via a N3AN. The transceiver receives a PLMN list and at least one S-NSSAI list from a network entity (e.g., from a first N3AN). Here, the PLMN list including a first PLMN, where the at least one S-NNSAI list indicates a set of S-NSSAI corresponding to the first PLMN. The processor selects a N3AN based on the S-NSSAI list, where the selected N3AN supports connectivity to a particular network slice of the first PLMN. The processor registers with the particular network slice of the first PLMN over the selected N3AN, where the registration allows a S-NSSAI corresponding to the particular network slice.

In some embodiments, receiving the PLMN list and the S-NSSAI list includes receiving a generic container user data (“GUD”) that contains the PLMN list and the S-NSSAI list. In some embodiments, the PLMN list contains a set of PLMN information elements with which the network entity supports trusted 5G connectivity. Here, each PLMN information element may include a PLMN identity and a S-NSSAI list.

In some embodiments, the S-NSSAI list identifies a set of network slices for each PLMN in the PLMN list, where the network entity supports trusted 5G connectivity with each network slice identified by the S-NSSAI list. In some embodiments, the trigger is a request generated by one of: a UE application, and a URSP rule at the UE.

In some embodiments, each S-NSSAI in the S-NSSAI list contains an SST. In certain embodiments, at least one S-NSSAI in the S-NSSAI list also contains a mapped HPLMN SST. In some embodiments, at least one S-NSSAI in the S-NSSAI list contains a both an SST and a SD. In further embodiments, at least one S-NSSAI in the S-NSSAI list contains a mapped HPLMN SST and a mapped home PLMN SD.

In some embodiments, selecting the N3AN based on the S-NSSAI list includes analyzing the S-NSSAI list to identify a set of candidate N3ANs that support 5G connectivity to the particular network slice of the first PLMN. In certain embodiments, selecting the N3AN further includes applying one or more selection policy rules (e.g., WLANSP rules) to select a highest priority N3AN from the set of candidate N3ANs. In such embodiments, each S-NSSAI in the S-NSSAI list may contain an SST and a priority value. In further embodiments, at least one 20) S-NSSAI in the S-NSSAI list may also contain a mapped HPLMN SST, a SD and/or a mapped HPLMN SD.

In some embodiments, the processor establishing a data connection with the particular network slice. In certain embodiments, the selected N3AN is a trusted WLAN access network. In such embodiments, the data connection with the particular network slice includes a PDU session established via the trusted WLAN.

Disclosed herein is a second method for selecting a non-3GPP access network using announced supported S-NSSAIs, according to embodiments of the disclosure. The second method may be performed by a user equipment device in a mobile communication network, such as the remote unit 105, the UE 205, and/or the user equipment apparatus 1000, described above. The second method includes detecting a trigger to register with a particular network slice in a first PLMN via a N3AN and receiving, from a network entity (e.g., from a first N3AN), a PLMN list and at least one S-NSSAI list. Here, the PLMN list includes the first PLMN and the S-NNSAI list contains at least one S-NSSAI corresponding to the first PLMN. The second method includes selecting a N3AN based on the S-NSSAI list, where the selected N3AN supports connectivity to a particular network slice of the first PLMN. The second method includes registering with the particular network slice of the first PLMN over the selected N3AN, where the registration allows a S-NSSAI corresponding to the particular network slice.

In some embodiments, receiving the PLMN list and the S-NSSAI list includes receiving a GUD that contains the PLMN list and the S-NSSAI list. In some embodiments, the PLMN list contains a set of PLMN information elements with which the network entity supports trusted 5G connectivity. Here, each PLMN information element may include a PLMN identity and a S-NSSAI list.

In some embodiments, the S-NSSAI list identifies a set of network slices for each PLMN in the PLMN list, where the network entity supports trusted 5G connectivity with each network slice identified by the S-NSSAI list. In some embodiments, the trigger is a request generated by one of: a UE application, and a URSP rule at the UE.

In some embodiments, each S-NSSAI in the S-NSSAI list contains an SST. In certain embodiments, at least one S-NSSAI in the S-NSSAI list also contains a mapped HPLMN SST. In some embodiments, at least one S-NSSAI in the S-NSSAI list contains a both an SST and a SD. In further embodiments, at least one S-NSSAI in the S-NSSAI list contains a mapped HPLMN SST and a mapped home PLMN SD.

In some embodiments, selecting the N3AN based on the S-NSSAI list includes analyzing the S-NSSAI list to identify a set of candidate N3ANs that support 5G connectivity to the particular network slice of the first PLMN. In certain embodiments, selecting the N3AN further includes applying one or more selection policy rules (e.g., WLANSP rules) to select a highest priority N3AN from the set of candidate N3ANs. In such embodiments, each S-NSSAI in the S-NSSAI list may contain an SST and a priority value. In further embodiments, at least one S-NSSAI in the S-NSSAI list may also contain a mapped HPLMN SST, a SD and/or a mapped HPLMN SD.

In some embodiments, the second method further includes establishing a data connection with the particular network slice. In certain embodiments, the selected N3AN is a trusted WLAN access network. In such embodiments, the data connection with the particular network slice includes a PDU session established via the trusted WLAN.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
deciding to connect with a first network slice in a first Public Land Mobile Network (“PLMN”) via a non-3GPP access network;
sending a first request to each non-3GPP access network in a first list of non-3GPP access networks, the first request requesting cellular network information;
receiving a first response from at least one non-3GPP access network in the first list of non-3GPP access networks, each first response containing a first list of PLMNs and a plurality of supported network slices for each PLMN in the first list of PLMNs;
constructing a second list of non-3GPP access networks, wherein each non-3GPP access network in the second list supports connectivity with the first network slice in the first PLMN;
selecting a first non-3GPP access network from the second list of non-3GPP access networks; and
sending a registration request to the first PLMN via the first non-3GPP access network, wherein the registration request indicates that registration with the first network slice is required.

2. The method of claim 1, wherein receiving the first response comprises receiving a generic container that contains the first list of PLMNs and the plurality of supported network slices.

3. The method of claim 2, wherein the plurality of supported network slices comprises a Single Network Slice Selection Assistance Information (“S-NSSAI”) list that identifies a set of network slices for each PLMN in the first list of PLMNs.

4. The method of any preceding claim, wherein each PLMN in the first list of PLMNs identifies a PLMN with which 5G connectivity is supported by the non-3GPP access network that sent the first list of PLMNs.

5. The method of any preceding claim, wherein the first list of PLMNs comprises a set of PLMN information elements, wherein each PLMN information element includes a PLMN identity and a Single Network Slice Selection Assistance Information (“S-NSSAI”) list.

6. The method of claim 5, wherein each S-NSSAI in the S-NSSAI list comprises a slice service type (“SST”) and at least one of: a slice differentiator (“SD”) and a priority value.

7. The method of any preceding claim, wherein selecting the first non-3GPP access network comprises applying one or more selection policy rules to select a highest priority non-3GPP access network from the second list of non-3GPP access networks.

8. The method of any preceding claim, further comprising establishing a data connection with the first network slice.

9. The method of claim 8, wherein the first non-3GPP access network comprises a trusted Wireless Local Area Network (“WLAN”) access network, wherein the data connection with the first network slice comprises a packet data unit (“PDU”) session established via the trusted WLAN.

10. The method of any preceding claim, wherein deciding to connect with the first network slice occurs in response to receiving an internal request to establish a data connection with a first network slice, the request generated by one of: a UE application, and a UE Route Selection Policy (“URSP”) rule in the UE, wherein the URSP rule indicates that the data connection with the first network slice should be established over a non-3GPP access network.

11. A user equipment (“UE”) apparatus comprising:
a processor that decides to connect with a first network slice in a first PLMN via a non-3GPP access network;
a transceiver that:
sends a first request to each non-3GPP access network in a first list of non-3GPP access networks, the first request requesting cellular network information; and
receives a first response from at least one non-3GPP access network in the first list of non-3GPP access networks, each first response containing a first list of PLMNs and a plurality of supported network slices for each PLMN in the first list of PLMNs;
wherein the processor further:
constructs a second list of non-3GPP access networks, wherein each non-3GPP access network in the second list supports connectivity with the first network slice in the first PLMN;
selects a first non-3GPP access network from the second list of non-3GPP access network; and
sends a registration request to the first PLMN via the first non-3GPP access network, wherein the registration request indicates that registration with the first network slice is required.

12. The apparatus of claim 11, wherein receiving the first response comprises receiving a generic container that contains the first list of PLMNs and the plurality of supported network slices.

13. The apparatus of claim 12, wherein the plurality of supported network slices comprises a Single Network Slice Selection Assistance Information (“S-NSSAI”) list that identifies a set of network slices for each PLMN in the first list of PLMNs.

14. The apparatus of claim 11, 12 or 13, wherein each PLMN in the first list of PLMNs identifies a PLMN with which 5G connectivity is supported by the non-3GPP access network that sent the first list of PLMNs.

15. The apparatus of any of claims 11 to 14, wherein the first list of PLMNs comprises a set of PLMN information elements, wherein each PLMN information element includes a PLMN identity and a Single Network Slice Selection Assistance Information (“S-NSSAI”) list.

16. The apparatus of claim 15, wherein each S-NSSAI in the S-NSSAI list comprises a slice service type (“SST”) and at least one of: a slice differentiator (“SD”) and a priority value.

17. The apparatus of any of claims 11 to 16, wherein selecting the first non-3GPP access network comprises applying one or more selection policy rules to select a highest priority non-3GPP access network from the second list of non-3GPP access networks.

18. The apparatus of any of claims 11 to 17, wherein the processor establishes a data connection with the first network slice.

19. The apparatus of claim 18, wherein the first non-3GPP access network comprises a trusted Wireless Local Area Network (“WLAN”) access network, wherein the data connection with the first network slice comprises a packet data unit (“PDU”) session established via the trusted WLAN.

20. The apparatus of any of claims 11 to 19, wherein deciding to connect with the first network slice occurs in response to receiving an internal request to establish a data connection with a first network slice, the request generated by one of: a UE application, and a UE Route Selection Policy (“URSP”) rule in the UE, wherein the URSP rule indicates that the data connection with the first network slice should be established over a non-3GPP access network.
